(19) United States
(12) Patent Application Publication
(10) Pub. No.: US 2006/0169842 A1
(43) Pub. Date: Aug. 3, 2006

(54) Method at loading and unloading of goods in aircraft

(76) Inventor: Magnus Rehn, Bromma (SE)

Correspondence Address: ALFRED J MANGELS, 4729 CORNELL ROAD, CINCINNATI, OH, 452412433, US

(21) Appl. No.: 10/545,824

(22) PCT Filed: Jan. 26, 2004
(86) PCT No.: PCT/SE04/00093

§ 371 Date: Dec. 2, 2005

(30) Foreign Application Priority Data
Feb. 18, 2003 (SE) 0300438-9

(51) Int. Cl. B64D 9/00

(52) U.S. Cl. 244/137.1

(57) ABSTRACT

A security method for secure loading and unloading of goods to and from an aircraft. Items including freight and catering trolleys, following examination, have a transponder in which the identity and the destination of the goods are stored. A communicator at entrances of the aircraft reads information from the transponder on the items that are introduced into the aircraft. Persons that handle items on the way to and at the aircraft have a transponder that includes the person's identity. A communicator on the relevant goods transporter for the items transported to the aircraft, and a communicator in or at the aircraft read information from the person's transponder. Information read from each transponder is stored in a central database, and is compared in a computer connected to the database with previously stored information. In the case of a discrepancy in the information an alarm is given.

### BACKGROUND OF THE INVENTION

1. Field of the Invention

The present invention concerns a method for loading and unloading aircraft.

The method is aimed at increasing security, creating traceability, and making possible the verification of and obtaining documentation concerning the loading and unloading of aircraft.

2. Description of the Related Art

There has been a great need for increasing the security at airports ever since the terrorist attacks against the World Trade Center on 11 Sep. 2001. Many initiatives have been taken using different means in order to increase protection against attacks and against terrorist deeds. These have principally been directed at preventing attacks against aircraft in the air. This has meant that passengers have been checked more rigorously, that luggage has been examined using X-rays, and that personnel at airports have been checked during passage to and from the outward-bound regions of the airport. Attempts have been made to couple passengers and their luggage to particular departures, and in the event of a passenger choosing not to board an aircraft, this leads to the luggage of this passenger being unloaded.

Airports have been equipped during recent years with check-in machines, and the use of boarding-card machines during embarkation is very well established. This has also been supplemented with what are known as “e-tickets,” where the air ticket is registered against a selected credit card and information is stored in central databases to be presented once a passenger uses the credit card.

Various concepts have been presented as a new aspect in order to make use of biometric identification in order to verify that it is the correct person who has the right to board a certain aircraft. This may be with the aid of fingerprint recognition, retina scanning, or facial recognition. The aim is to exploit unique individual properties in order to avoid the risk that cards may be forged, exchanged, or copied.

The examinations that have been relatively extensive for a long period have been investigation of carry-on luggage. The contents have been examined using X-ray equipment and, where necessary, bags have been opened for a more detailed examination.

It has become clear that checked-in luggage contained a time-bomb, in the Lockerbee accident in Scotland, in which a Pan Am aircraft crashed following an explosion in the air.

The examination and registration of luggage that is currently carried out mainly satisfies two needs: not only does it make possible the transport of luggage to the correct destination, it also makes it possible to investigate that luggage does not contain any dangerous objects at all.

The major part of air-freighted goods is transported in aircraft containers, so called “ULDs” (Universal Load Devices) or on transportable pallets known as “flatbeds.” This is in order to make loading and unloading of the aircraft as rapid and as simple as possible, and in order to make possible maximal use of the existing space. There is a need for tracing the goods, and for this reason load-carriers have identification in the form of a paper code that is affixed before each journey. The containers themselves are not currently subjected to any real security examination, it is the freight company itself that prepares these before a journey.

For most flights, food and other catering equipment constitutes a not insignificant part of what is planned and loaded before the flight. These originate in a catering kitchen, which is normally located inside the airport area, but not on the outward-bound side of the airport. The transport from the kitchen to the aircraft thus passes through gates. Food trolleys are rolled onboard by means of what are known as “highloaders,” and they are left to fly with the aircraft. Different systems have been tried at the kitchen for controlling the transporters that are to provide the aircraft with food, and to ensure that it is delivered in time. A visual examination of the loading is currently carried out by one responsible person on board, who checks the trolleys against a list that exists concerning number of passengers, etc.

The same is true for trolleys with tax-free articles.

There are many inadequacies, in spite of all the examinations. One such inadequacy is that handling luggage that has already been checked in, and other goods that are to be loaded onto the aircraft, may be carried out in a faulty manner such that goods that are not to be carried are erroneously loaded onto the aircraft.

All of these measures have also meant that the time required to carry out the necessary examinations has increased, and that the costs for the air industry have risen. There is a need for the future to discover solutions that provide increased protection, while at the same time giving efficient handling of passenger traffic.

The discussion concerning issues with respect to air security has shown that increased protection is desirable with respect to all forms of loading and unloading aircraft.

The present invention offers a method that significantly increases security.

### SUMMARY OF THE INVENTION

The present invention is based on increasing the security with respect to goods of various types that are loaded into an aircraft before take-off.

The present invention thus relates to a method for loading and unloading goods to and from an aircraft. Goods, including freight and/or so-called catering trolleys, are equipped following examination with a transponder in which the identity and, possibly, the destination of the goods is stored. A communicator at the entrances of the aircraft for freight and for catering trolleys reads the transponder on the goods that are introduced into the aircraft. The personnel that handle the goods on the way to and at the aircraft are provided with a transponder including the identity of the person in question. A communicator in the relevant transport means for the goods to the aircraft and a communicator in or at the aircraft read the transponder on the personnel in question. The information read from each transponder is stored in a central database, and the information is compared by a computer connected to the central database. In the case of a discrepancy in the information an alarm is given.

### BRIEF DESCRIPTION OF THE DRAWING

The invention is described in more detail below, partially in connection with the attached drawing in which:

FIG. 1 shows schematically a communication system including a transponder and a communicator; and

FIG. 2 is a block diagram that shows an example of the invention.

### DESCRIPTION OF THE PREFERRED EMBODIMENTS

The present invention concerns loading and unloading of goods into and from an aircraft, and, in particular, loading of goods in preparation for a flight.

With respect to passengers and their luggage, it is highly advantageous to use the method that is described in the Swedish patent application number 0300437-1.

According to the present invention, goods, including at least freight and/or catering trolleys, are equipped following examination with a transponder in which the identity of the goods is stored. “Catering trolleys” is here taken to denote conventional trolleys for food, drinks, tax-free items, and equivalent goods.

A first transponder is programmed and attached to or placed into examined freight. A second transponder is programmed and attached to or placed into each catering trolley. “Programmed” here means the storage of the information in a memory in each transponder by means of a communicator.

Known automatic identification systems that use radio frequencies, known as “RFID” (Radio Frequency Identification) systems, contain identification tags (ID-tags) and communicators. One known type of identification tag includes an antenna, a modulator, and a circuit for control logic in order to control the modulator. Such a known ID-tag is designed such that it is arranged to receive a signal transmitted from a communicator and to reflect this signal in modulated form.

The ID-tag is applied to the object or person that is to be identified. The identity can be read by a communicator at a certain short distance, for example, five meters. It is also possible, depending on the design, to read and write other information into the ID-tag with the aid of the communicator, in addition to an identity.

The relatively short range, five meters for example, makes it possible to communicate with the ID-tags within a geographically limited region of communication.

Such an RFID system is used according to one preferred embodiment of the present invention. However, another, equivalent system, such as a Bluetooth system, can be used instead in which transponders and communicators communicate using the technology known as Bluetooth.

According to the invention, a first communicator at the entrances of the aircraft for freight and a second communicator at the entrances of the aircraft for catering trolleys read the transponders on the goods that are loaded into the aircraft.

The personnel that handle the goods on their way to and at the aircraft are also equipped with a transponder including the identity of the person in question.

A communicator in the relevant means of transport for goods to the aircraft and a communicator in or at the aircraft read the transponder of the personnel in question.

Furthermore, the information read from each transponder is, according to the invention, stored in a central database.

The information is compared by a computer connected to the central database. In the case of a discrepancy in the information, an alarm is given.

Thus, by the disclosed procedures, information will be available at least with respect to which goods and which catering trolleys have been loaded, by which members of the personnel staff, and which vehicles have been used.

It is in this way possible to create an expectation that the correct goods and catering trolleys have been loaded in the correct manner. However, this depends on the central database retrieving information from other databases in the various computer systems of the airport, databases with respect to preparation of freight, catering trolleys, and tax-free trolleys, together with which personnel are on duty, which vehicles are being used, which aircraft are to be loaded, etc. That information is available in the various computer systems.

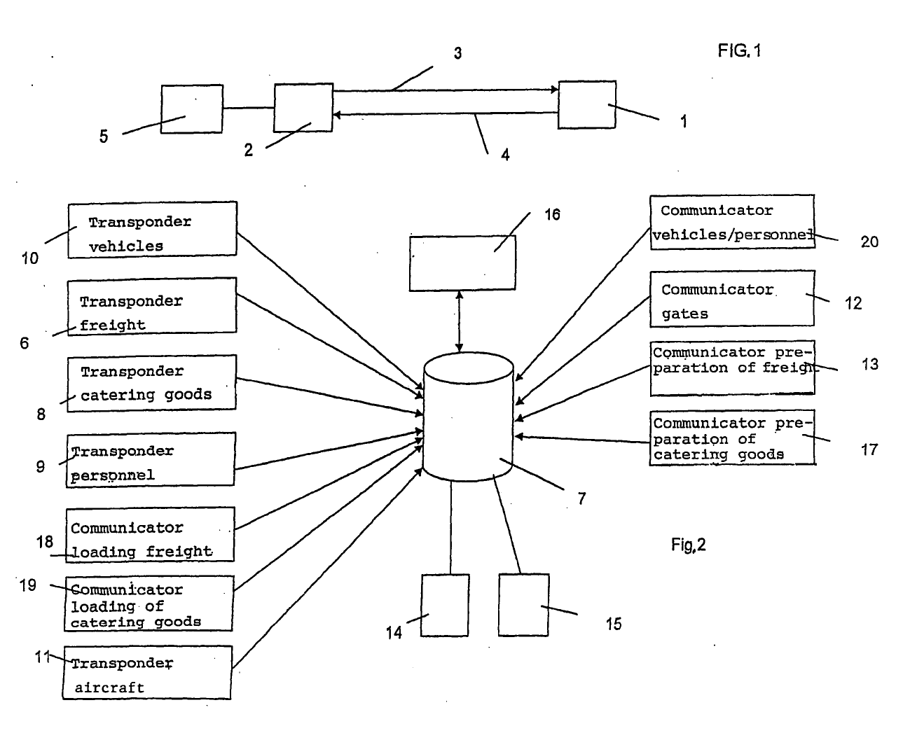

A communication unit for the identification of objects or persons is shown schematically in FIG. 1. The communication unit includes a transponder 1 and a communicator in the form of a receiver/transmitter unit 2. The communicator 2 is arranged to transmit a query signal 3 to the transponder 1. The transponder is arranged to receive the query signal and thereby reflect and modulate the query signal. The communicator 2 is arranged to receive the reflected signal 4 and to decode its information content. The communicator 2 is connected to a supervisory computer system 5 in a suitable way, such as cable, radio, W-Lan, GSM/GPRS/G3, or similar.

FIG. 2 shows a block diagram in order to illustrate the operation of the present invention.

Reference numeral 7 in FIG. 2 identifies the central database, and reference numeral 16 the computer.

A first transponder 6 is attached to or placed into freight that is prepared and that has been approved. It is appropriate that the transponder contains information concerning an ID number for the freight, the destination of the freight, and the aircraft with which the freight is to be transported. The transponder is programmed with information by means of a communicator 13, which may be fixed or portable.

Catering trolleys and tax-free trolleys are equipped in a similar manner with a second transponder 8 that contains information that the trolley has been approved and onto which aircraft the trolley is to be loaded. The transponder is programmed by means of a communicator 17 located at the packing location of the trolley. Alternatively, the communicator 17 may be portable.

The transponders may, alternatively, contain solely an ID number, and it may not be possible to program them with an ID number. In this case, information about approval, destination, contents, etc., can be retrieved from a central database at the airport. In this case, the ID number of the transponder is fed into the last mentioned central database together with other information. When the transponder is subsequently read by a communicator, the read ID number can thus be paired with the stored information desired.

Each vehicle is equipped with a communicator 20 that reads the identity of the personnel.

Since catering kitchens and equivalent premises often lie outside of the outwardly bound region of an airport, fixed communicators 12 can be installed at gates and routes that the vehicle passes in order to obtain access to the outwardly bound regions.

During loading of the aircraft, the aircraft can be identified by the aircraft having been equipped with a transponder 11 that is read by communicators 18, 19 at the loading entrances of the aircraft, whereby this information is transferred to the central database 7. Furthermore, the communicators 18, 19, which may include several different communicators, are arranged to read the transponders 6, 8 on all goods and all trolleys that are loaded.

Thus, it is preferred that, in the case in which the communicators 18, 19 at the entrances of the aircraft are independent of the aircraft, the aircraft is equipped with a transponder 11 that specifies the identity of the aircraft, which is caused to be read by one of the communicators 18, 19, or by another communicator.

The communicators 18, 19 may also read the relevant transponder 10 of the vehicles.

All information read by the communicators is transferred to the central database 7.

The arrows in FIG. 2 pointing into the central database illustrate that the information in all transponders and all communicators is transferred to the central database 7.

As has been described above, the information is compared by a computer 16 connected to the central database 7. In the case in which a discrepancy is present in the information, an alarm is given by a suitable alarm means 14, 15.

One discrepancy may be that goods have been loaded incorrectly, that a catering trolley has been loaded incorrectly, that the wrong personnel have carried out the loading, that the wrong vehicle has been used, etc., relative to the information that has been received concerning freight, catering, personnel, and vehicles from the various computer systems.

According to one preferred embodiment, the alarm is given at at least one location, and the discrepancy is displayed at this location on a display such that security personnel can make a decision concerning what measures are to be taken.

According to one highly preferred design, an alarm is given at at least two different locations located at a large distance from each other, in order to make manipulation of the alarm means more difficult.

It is in this case preferred that the alarm means is located in the control tower of the airport. This ensures that an aircraft does not receive permission to take-off if the system has discovered a discrepancy in the information of the type described above.

This system, finally, will offer reports in order to be able to follow and to document the events that have taken place. This means that the events, at least to a certain extent, can be reconstructed in the case for which a passenger has attempted to circumvent currently valid routines.

By identifying and verifying sensed information against a central database having relevant information, or with interacting and coordinated central databases, a secure, real-time-adapted check is obtained. Advantages include increased security, increased efficiency, and automatic documentation of all events. A system is in this way created that has high performance and high flexibility at a reasonable cost, since many of the components that are needed are already available in use.

A number of embodiments have been described above. It is, however, clear that the routines described can be changed without deviating from the invention.

The present invention is, for this reason, not to be considered as limited to the embodiments described above, since variations can be made within the scope of the accompanying claims.

What is claimed is:

1. A method for loading and unloading goods from an aircraft, which respective goods are provided with a transponder in which at least one of the identity and the destination of the goods is stored, and where a communicator reads information from the transponder on the goods that are introduced into the aircraft, said method comprising the steps of: equipping goods including at least one of freight and catering trolleys with a transponder after examination of the goods: providing a communicator at entrances to the aircraft for freight and for catering trolleys for reading information transmitted by a transponder providing to a person that handles the goods on the way to and at the aircraft a personnel transponder including the identity of the person reading information transmitted by a personnel transponder by a communicator a transport means for transporting the goods to the aircraft and by a communicator in or at the aircraft: transmitting from a communicator and storing in a central database information read from each transponder comparing in a computer connected to the central database the information read by the communicators from each transponder with information previously stored in the central database; and providing an alarm signal in the case of a discrepancy in the compared information.

2. A method according to claim 1, including the steps of: providing an alarm signal at at least one location, and displaying any discrepancy on a display in order for security personnel to determine what measures should be taken.

3. A method according to claim 2, wherein the alarm signal is given at at least two different locations.

4. A method according to claim 1, wherein the transponders are RFID-transponders.

5. A method according to claim 1, including the step of providing in a transponder on the goods at a location at which the goods are prepared information confirming that the goods have been examined and approved for loading into the aircraft.

6. A method according to claim 1, including the step of providing in a transponder on the trolleys at a location at which the trolleys are prepared and packed information confirming that the trolleys have been examined and approved for loading into the aircraft.

7. A method according to claim 1, wherein when communicators at entrances to the aircraft are independent of the aircraft, step of equipping the aircraft with a transponder that is read by at least one of the communicators after which information that is read is transferred to the central database.
